(19) United States
(12) Patent Application Publication
(10) Pub. No.: US 2012/0038780 A1
(43) Pub. Date: Feb. 16, 2012

(54) APPARATUS AND METHOD FOR INSPECTING DISPLAY DEVICE

(76) Inventors: Seung-Hwa JEON, Gumi (KR); Gun Hee Lee, Gumi (KR); Won-Gyu Jang, Gumi (KR); Moon-Joon Kim, Seoul (KR)

(21) Appl. No.: 13/034,484

(22) Filed: Feb. 24, 2011

(30) Foreign Application Priority Data
Aug. 11, 2010 (KR) 10-2010-0077458

(51) Int. Cl. H04N 17/00

(52) U.S. Cl. 348/189; 348/E17.001

(57) ABSTRACT

Disclosed is an inspection apparatus for a display device capable of implementing fast inspection of the display device, the apparatus including a plurality of stages on which at least one display panel is loaded, and at least one camera at one of the plurality of stages to photograph the display panel on the corresponding stage, with moving from one side to another of the display panel, to inspect a defect of the display panel.

### CROSS-REFERENCE TO RELATED APPLICATION

This application claims the benefit of Korean Patent Application No. 10-2010-0077458, filed on Aug. 11, 2010, which is hereby incorporated by reference for all purposes as if fully set forth herein.

### BACKGROUND OF THE INVENTION

1. Field of the Invention

The present application relates to an apparatus and method for inspecting a display device.

2. Discussion of the Related Art

Recently, the development of various types of portable electric equipment, such as mobile phones, personal digital assistants (PDAs) and notebook computers, is increasing due to the demands on flat panel display devices, which are small in size, lightweight and power-efficient and are thus applicable to those equipment. Examples of the flat panel display device are liquid crystal display (LCD) devices, plasma display panel (PDP) devices, field emission display (FED) devices, vacuum fluorescent display (VFD) devices and the like. Studies on these devices are actively conducted. Among others, LCD devices are currently in the limelight in view of their mass production technology, facilitation of driving scheme and implementation of high color rendering property.

LCD displays information on a screen by virtue of refractive index anisotropy of liquid crystal. As shown in FIG. 1, an LCD device 1 includes a first substrate 3, a second substrate 5 and a liquid crystal (LC) layer 7 interposed between the first substrate 3 and the second substrate 5. The first substrate 3 is a transistor array substrate. Although not shown, the first substrate 3 includes a plurality of pixels, each having a driving device, such as a thin film transistor (TFT). The second substrate 5 is a color filter substrate, which includes color filter layers for rendering real colors. Also, the first and second substrates 3 and 5 have a pixel electrode and a common electrode, respectively, and are coated with an alignment layer for aligning liquid crystal molecules of the LC layer 7.

The first and second substrates 3 and 5 are bonded to each other by a sealing material 9, and the LC layer 7 is formed between the sealing materials 9. Accordingly, the driving devices formed on the first substrate 3 drive the liquid crystal molecules to control an amount of light transmitted through the LC layer 7, thereby displaying information.

A fabrication process of the LCD device may be divided into a TFT array process of forming a TFT on the first substrate 3, a color filter process of forming the color filter on the second substrate 5, and a cell process, which will be described with reference to FIG. 2 hereinafter.

As shown in FIG. 2, through the TFT array process and the color filter process, a TFT, namely, a driving device, and a color filter layer are formed respectively on the first substrate 3 and the second substrate 5, as the mother-glass substrates have a plurality of liquid crystal panel regions (S101 and S104). Afterwards, an alignment layer is coated respectively on the first substrate 3 having the TFT and the second substrate 5 having the color filter layer for a rubbing process (S102 and S105). Liquid crystal is then dropped on the LC panel regions of the first substrate 3 and a sealing material 9 is coated along an edge region of the LC panel of the second substrate 5 (S103, S106).

Afterwards, pressure is applied to the first and second substrate 3 and 5, which are in an aligned state, so as to bond them to each other by the sealing material 9 and simultaneously to uniformly distribute the dropped liquid crystal (S107). Through those processes, a plurality of liquid crystal panels having the LC layer are formed on the large glass substrate (i.e., first and second substrates 3 and 5). The glass substrate is then processed and cut out into a plurality of LC panels. Each LC panel is inspected, thereby fabricating an LCD device (S108 and S109).

As aforesaid, in the related art LCD fabrication method, the liquid crystal is dropped on the substrate, on which the plurality of LC panels are to be formed, and the first and second substrates 3 and 5 are bonded to each other to be divided into unit panels, thereby fabricating the LCD.

The LC panel may be inspected in various manners. A representative among them is an auto probe inspection using a vision auto probe (VAP) apparatus. The auto probe inspection is to automatically recognize a defective LC panel and defect location information using an area camera or a line camera.

The VAP apparatus includes a VAP frame defining an overall appearance, a work table for placing an LC panel thereon, a pad for applying a signal to the LC panel, a camera for receiving image information of the LC panel, a camera supporting frame for allowing movement of the camera, and the like.

In the meantime, the camera of the VAP apparatus is typically implemented using an area scan camera. In order to reduce a defect error rate of the LC panel, detection should be performed using the area scan camera with a high magnification ratio. However, the detection in the high magnification ratio may increase the number of area scan cameras, which causes an increase in a fabrication cost.

Also, even if the inspection is performed using the VAP apparatus by increasing the number of area scan cameras, an interruption may occur between the area scan cameras, thereby giving rise to difficulty of an accurate defect detection.

Furthermore, in order to detect spots where the LC panel looks like being stained as light is partially leaked according to a viewing angle (angular field) due to the lack of bonding margin or an incorrect bonding of the LC panel, a viewing angle inspection of the LC panel is needed. However, the area scan cameras cannot perform the viewing angle inspection, and consequently, such inspection is difficult to be performed.

### SUMMARY OF THE INVENTION

Accordingly, the present invention is directed to an apparatus and method for inspecting a display device that substantially obviates one or more of the problems due to limitations and disadvantages of the related art.

An advantage of the present invention is to provide an apparatus and method for inspecting a display device that allows a fast inspection of the display device.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, an inspection apparatus for a display device may include a plurality of stages on which at least one display panel is loaded, and a first camera at one of the plurality of stages to photograph a display panel loaded on the corresponding stage with moving from one side to another side of the display panel to inspect a defect of the display panel.

The first camera may be a line scan camera, an area camera or time delay and integration (TDI) camera. The apparatus may further include a plurality of second cameras for viewing angle inspection, inclined by a preset angle in a diagonal direction of the display panel to execute a left and right viewing angle inspection of the display panel loaded on the corresponding stage.

One first camera may be disposed at each stage. Here, the first camera may photograph a display panel loaded on a stage with moving from one side to another of the display panel.

Also, when a plurality of first cameras are disposed at one stage and a plurality of display panels are loaded on the one stage, one of the first cameras may be moved to one region of a plurality of regions where the plurality of display panels are located on the corresponding stage so as to photograph a display panel present on the corresponding region, and another first camera may be moved to another region to photograph a display panel present on the corresponding region.

In accordance with another exemplary embodiment, an inspection apparatus for a display device may include a plurality of stages on which a plurality of display panels are loaded, respectively, and a plurality of first cameras to move among the plurality of stages, the plurality of first cameras photographing the plurality of display panels loaded on the respective stages, with moving from one side to another of the display panels, so as to inspect defects of the display panels.

Here, while one display panel is loaded on or unloaded from one stage, the first camera may photograph a display panel loaded on another stage.

In accordance with one exemplary embodiment, an inspection method for a display device may include loading display panels on a plurality of stages, respectively, and disposing at least one camera at each of a plurality of stages to photograph the display panel loaded on the corresponding stage, with moving the at least one camera from one side to another of the display panel, to inspect a defect of the display panel.

After a plurality of display panels are loaded on one stage or a plurality of stages, the loaded display panels can be scanned (photographed, taken, captured) simultaneously or sequentially by one camera or a plurality of cameras, thereby allowing a rapid inspection. Furthermore, upon loading or unloading one display panel, another display panel can be inspected, so as to realize an efficient inspection.

Also, viewing angle inspection cameras may also be equipped in addition to the camera(s), so as to allow a fast and accurate viewing angle inspection as well as a defect inspection.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view illustrating a typical structure of an LCD device;

FIG. 2 is a flowchart illustrating a typical method for fabricating an LCD device;

FIG. 3 is a schematic view illustrating an apparatus for inspecting a display device in accordance with one exemplary embodiment;

FIG. 4 is a view illustrating an inspection part of the inspection apparatus;

FIG. 5 is a view illustrating a conveying path of the LC panel on the inspection apparatus;

FIGS. 6A to 6D are views sequentially illustrating a method for inspecting an LC panel in accordance with one exemplary embodiment;

FIG. 7 is a view illustrating a viewing angle inspection camera of the inspection apparatus; and

FIG. 8 is a view illustrating a viewing angle inspection camera, having a plane mirror, of the inspection apparatus.

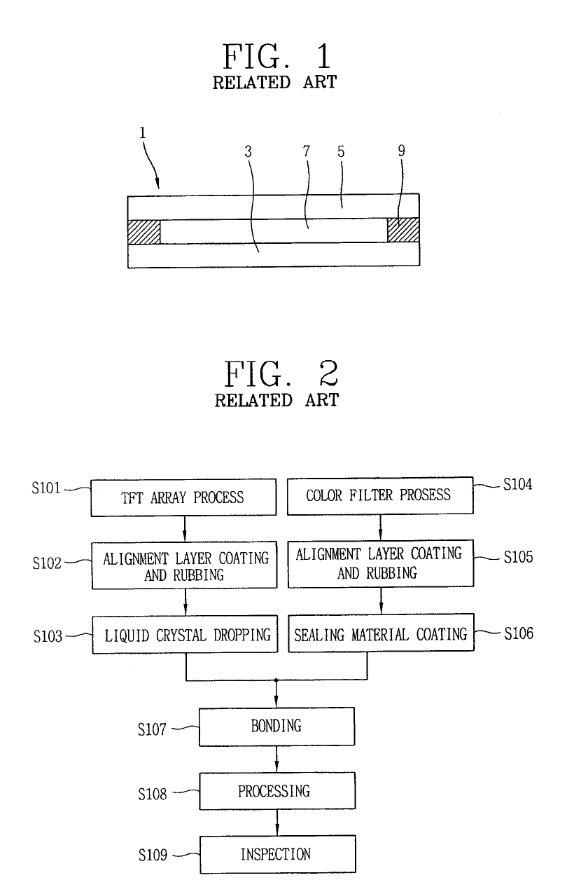

### DETAILED DESCRIPTION OF THE INVENTION

Reference will now be made in detail to embodiments of the present invention, example of which is illustrated in the accompanying drawings. The same reference numbers may be used throughout the drawings to refer to the same or like parts.

For a rapid inspection of a flat panel display device, a plurality of stages are prepared, and the flat panel display device is loaded on each stage to sequentially or simultaneously photograph the flat panel display device loaded on each stage using a camera, thereby performing inspection. The camera may be installed at each stage to photograph the flat panel display device loaded on the stage, or a single camera may be installed to photograph the flat panel display device loaded on each stage. Here, the flat panel display devices, which have undergone the preceding processes, are loaded sequentially, which allows a rapid inspection thereof.

Meanwhile, an inspection apparatus in accordance with the present invention can be used for various types of flat panel display devices, for example, an LCD device, an organic light emitting diode (OLED) device, a plasma display device and the like. Further, an inspection apparatus of the present invention may also be used for a solar cell. Hence, the following description herein exemplarily illustrates, but is not limited to, a specific flat panel display device. Rather, the inspection apparatus may also be applicable to any type of flat panel display devices.

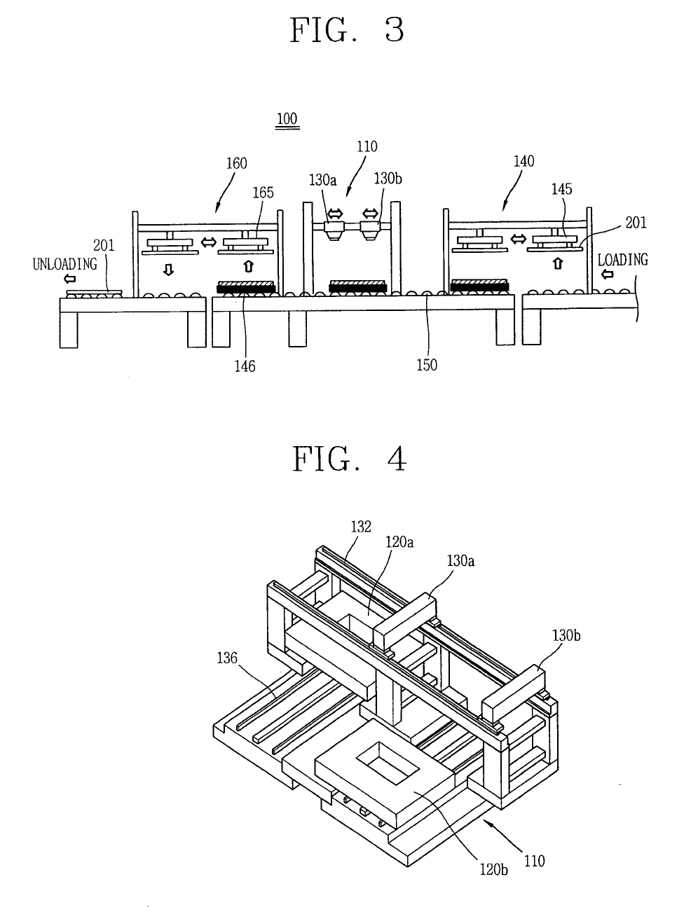

FIG. 3 is a schematic view of an apparatus for inspecting a display device in accordance with one exemplary embodiment. As illustrated in FIG. 3, an inspection apparatus 100 inspects whether or not a display device fabricated through various processes has a defective portion, and may include a loader part, an inspection part and an unloader part.

The inspection apparatus 100 may include a conveyer 150 for conveying a display device, for example, an LC panel 201, which has undergone various processes, such as a TFT process, a color filter process and the like, to the loader part, the inspection part and the unloader part, a first conveying unit 140 included in the loader part for loading a target to be inspected, such as the LC panel 201, to convey to a palette 146, a first camera 130a and a second camera 130b both installed at the inspection part for determining whether any defect is found on the LC panel 201 loaded on the palette 146, and a second conveying unit 160 installed at the unloader part for unloading the LC panel 201 that has been inspected for determination as to existence or non-existence of a defect by scanning of the first and second cameras 130a ad 130b.

Here, the LC panel 201 inspected in the inspection part may include a form of a cell or a form of a module.

The first conveying unit 140 may include a first lifting portion 145 for lifting up and down the LC panel 201 loaded by the conveyer 150 to transport to the palette 146, and a second lifting portion 165 for lifting up and down the LC panel 201, which is sent back by the conveyer 150 after the inspection process in the inspection part so as to unload the LC panel 201.

Although not shown, the palette 146 may include a work table for placing the LC panel thereon to perform a defect inspection thereof, a probe unit attached onto the LC panel placed on the work table for applying an electric signal to the LC panel 201, and a base plate having a probe unit for each of gate and data lines of the LC panel 201.

The palette 146 may be provided one by one at the loader part, the inspection part and the unloader part. Accordingly, the palettes 146 may circulate in sequence of the loader part, the inspection part and the unloader part so as to sequentially transport the LC panels 201 to the loader part, the inspection part and the unloader part.

Here, at least two palettes 146 may be installed to consecutively transport the LC panels 201 by circulating the loader part, the inspection part and the unloader part, thereby allowing the rapid inspection of the LC panels 201.

The first camera 130a and the second camera 130b may be disposed above the inspection part to photograph the loaded LC panels. Here, the first camera 130a and the second camera 130b may be a line scan camera for scanning the LC panel 201 by each line or an area camera for photographing the LC panel 201 by each area.

In the meantime, while running the LC panel 201, if the line scan cameras 130a and 130b are used to perform a defect inspection, a driving signal having a specific period is applied to the LC panel 201, thereby rendering an image having the specific period on the LC panel 201. Consequently, a case where the line scan cameras 130a and 130b are difficult to acquire normal images may occur.

In this case, in place of the line scan cameras 130a and 130b for scanning line by line, a time delay and integration (TDI) camera, which scans a plurality of lines and accumulates images acquired from the plurality of lines so as to level the images, may be used.

Although not shown, the inspection apparatus 100 may include a vision hardware for processing information transferred from the first and second cameras 130a and 130b into images recognizable by an operator, an image display unit for displaying the images processed by the vision hardware, and a defect map for displaying defects of the LC panel 201, which is inspected.

The inspection part of the inspection apparatus may further include a backlight unit (not shown) for emitting light to the LC panel 201 placed on the palette 146.

FIG. 4 is a view illustrating the inspection part of the inspection apparatus 100 having the structure.

As illustrated in FIG. 4, the inspection part may include a base 110, a first stage 120a and a second stage 120b installed on the base 110 for placing the transferred LC panel 201 thereon, first guide rails 136 installed on the base 110 for conveying the first stage 120a and the second stage 120b to portions where the first and second camera 130a and 130b are located, and second guide rails 132 installed on the base 110 for moving the first and second cameras 130a and 130b.

As described above, the two stages 120a and 120b are installed at the inspection part such that the LC panel 201 can be loaded on each of them to be inspected. In other words, two sheets of LC panels 201 may be loaded to be inspected. Here, the LC panels may sequentially be loaded on the first and second stages 120a and 120b and photographed by the first and second cameras 130a and 130b for inspection.

Here, FIG. 4 exemplarily shows that two cameras are installed at the stages 120a and 120b, separately, so as to photograph the LC panels 201 loaded on the corresponding stages 120a and 120b for inspection. Alternatively, one camera may merely be installed at the two stages 120a and 120b to photograph each of the LC panels 201 loaded on each of the stages 120a and 120b. In this structure, the LC panels may be sequentially or simultaneously loaded on each stage 120a and 120b. Thereafter, the one camera may photograph the LC panel 201 loaded on one stage and then move to another stage to photograph the LC panel loaded thereon. Here, the previously inspected LC panel may be conveyed to the unloader part, and another LC panel 201 is loaded on this stage while the inspection is performed on another stage, thereby allowing a consecutive inspection.

Hereinafter, a method for inspecting the LC panel 201 using the inspection apparatus 100 having the structure will be described with reference to FIGS. 3 and 4.

Upon introducing an LC panel 201, which is fabricated through several processes, such as the TFT array process, the color filter process, the bonding process and the like, into the inspection apparatus 100, the LC panel 201 is loaded on the loader part. The loaded LC panel 201 is placed on the palette 146 by the first lifting portion 145 of the first conveying unit 140. The LC panel 201 placed on the palette 146 is transported to the first stage 120a of the inspection part by the conveyer 150. Afterwards, another LC panel 201 placed on the palette 146 is transported to the second stage 120b of the inspection part by the conveyer 150.

As soon as the palette 146 is moved to the first stage 120a, the palette 146 disposed at the unloader part is moved to the loader part to load the LC panel 201 thereon and thereafter moved to the second stage 120b of the inspection part.

The LC panel 201 transported to the loader part is placed on the work table provided at the palette 146 to be connected to the probe unit, thereby being under inspection as to existence or non-existence of a defect through the cameras 130a and 130b. Here, images of an inspection sample photographed by the cameras 130a and 130b are processed by a light information processor, so an automatic inspection can be achieved.

Although not shown, the probe unit may include a probe base, a printed circuit board (PCB) base, a manipulator, a Pogo block, a TCP block and a probe block. The probe block may be in contact with a panel pad so as to allow inspection by photographing the LC panel 201 using the cameras 130 and 130b.

The LC panel 201, which has been completely inspected on the inspection part, is loaded on the palette 146 to be conveyed by the conveyer 150. The LC panel 201 is then moved to the unloader part by being lifted up and down by the second lifting portion 165 of the second conveying unit 160, so as to be unloaded.

The palette 146 moved to the unloader part is then moved back to the loader part, and another LC panel 201 introduced in turn is placed on the palette 146 to be on standby.

As such, the inspection apparatus 100 having the structure may include the plurality of palettes 146, which circulate the loader part, the inspection part and the unloader part, so as to rapidly detect defective LC panels, which are sequentially loaded.

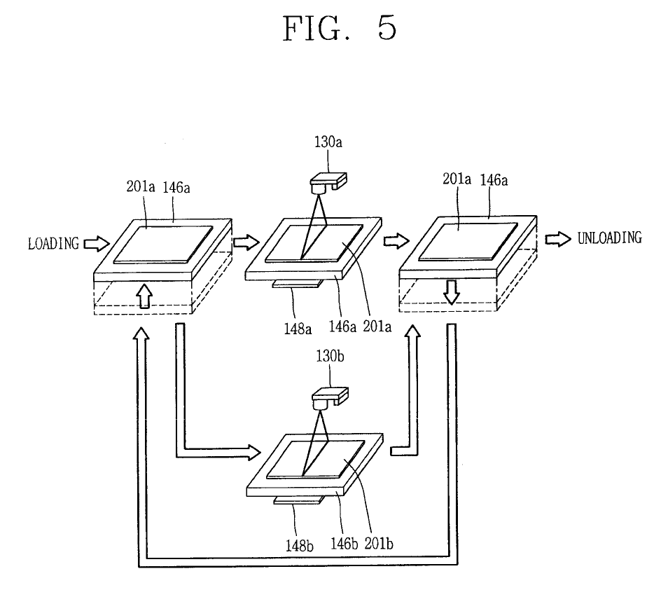

FIG. 5 is a schematic view illustrating a movement path of the LC panel 201 or the palette 146 in the inspection apparatus. The description of the movement path of the LC panel 201 or the palette 146 will specify the inspection process of the LC panel 201 more concretely.

Referring to FIGS. 3 and 5, the inspection apparatus 100 includes a loader part, an inspection part and an unloader part, each having four palettes.

A first LC panel 201a loaded on the palette 146a included in the loader part may be transported to a first stage 120a of the inspection part, and a palette 146a provided on the first stage 120a may be moved to the unloader part. That is, the first LC panel 201a is transported to the first stage 120a in the loaded state on the palette 146a to be photographed by the first camera 130a. Afterwards, the first LC panel 201a is conveyed to the unloader part. Although not shown, the first LC panel 201a transported to the first stage 120a may be in contact with the probe unit provided at the first palette 146a to be photographed by the first camera 130a, thereby being inspected as to whether or not a defect is present. When the first LC panel 201 a of the loader part is transported to the first stage 120a, another first LC panel 201a, which has been completely photographed on the first stage 120a, is conveyed to the unloader part.

Also, a second LC panel 201b loaded on a second palette 146b included in the loader part may be transported to a second stage 120b of the inspection part and a palette provided on the second stage may be moved to the unloader part. That is, the second LC panel 201b is transported to the second stage 120b in the loaded state on the second palette 146b to be photographed by the second camera 130b, thereby being conveyed to the unloader part. Although not shown, the second LC panel 201b transported to the second stage 120b may be in contact with the probe unit provided at the second palette 146b to be photographed by the second camera 130b, thereby being inspected as to whether or not a defect is present. When the second LC panel 201b of the loader part is transported to the second stage 120b, another second LC panel 201b, which has been completely photographed on the second stage 120b, is conveyed to the unloader part.

The first palette 146a provided at the unloader part is descended and moved to the loader part in a direction indicated with an arrow in the drawing.

As such, the plurality of stages 120a and 120b are provided, and the LC panels 201a and 201b are loaded on the stages 120a and 120b along different paths so as to be photographed by the cameras 130a and 130b installed at the respective stages 120a and 120b, thereby being inspected. Here, even at the moment when the LC panels 201a and 201b are loaded on the respective stages 120a and 120b, the photographing of an LC panel on another stage is in progress.

The first stage 120a and the second stage 120b of the inspection part may include a first backlight unit 148a and a second backlight unit 148b, respectively. The first and second backlight units 148a and 148b may be run when the first and second LC panels 201 and 201b placed on the first and second palettes 146a and 146b are transported to the first and second stages 120a and 120b of the inspection part to be photographed by the cameras 130a and 130b, thereby rendering test images on the first and second LC panels 201a and 201b.

The first and second LC panels 201 and 201b, which have completely undergone the defect inspection on the first and second stages 120a and 120b of the inspection part, are conveyed to the unloader part to be unloaded. Simultaneously, an LC panel, which has been transported to the loader part, is moved to the first and/or second stage(s) 120a, 120b of the inspection part and an LC panel, which has been transported to the unloader part, is moved to the loader part.

Therefore, an LC panel may be transported to the first or second stage 120a or 120b of the inspection part to be inspected as to whether or not a defect is present using the first or second camera 130a or 130b, and another LC panel is loaded on the loader part to be on standby for the next turn.

As aforesaid, the inspection apparatus 100 having the structure may have the plurality of palettes, which circulate the loader part, the first and second stages of the inspection part and the unloader part, so as to rapidly detect whether or not targets to be inspected, provided sequentially, have a defect or not.

Hence, the plurality of stages of the inspection part are provided and a plurality of LC panels are simultaneously or sequentially loaded on those stages in the loaded state on the palettes. Afterwards, the LC panels transported by the palettes are photographed by the cameras installed at the respective stages, thus to be fast inspected. Here, the LC panels loaded on the respective stages may be sequentially loaded on the first and second stages by virtue of the conveyer. Also, the first and second cameras can be moved above the first and second stages to photograph those LC panels, which makes it possible to simultaneously or sequentially inspect the plurality of LC panels.

Meanwhile, the inspection apparatus 100 may not be limited to the structure of having two stages at the inspection unit and cameras installed above the respective stages so as to inspect an LC panel loaded on each stage. As an alternatively example, the inspection apparatus 100 may have a structure that three or more stages may be provided at the inspection part and a camera is installed above each stage to photograph a plurality of LC panels for inspection at one time, or a structure that three or more stages are provided at the inspection part and one camera is installed to photograph every LC panels loaded on the three or more stages.

Hereinafter, various configurations (structures) will be schematically described. In the following description, those configurations will be simplified to briefly describe an inspection method for LC panels using stages and cameras. However, the practical structures of those apparatuses will be understood with reference to FIGS. 3 and 4.

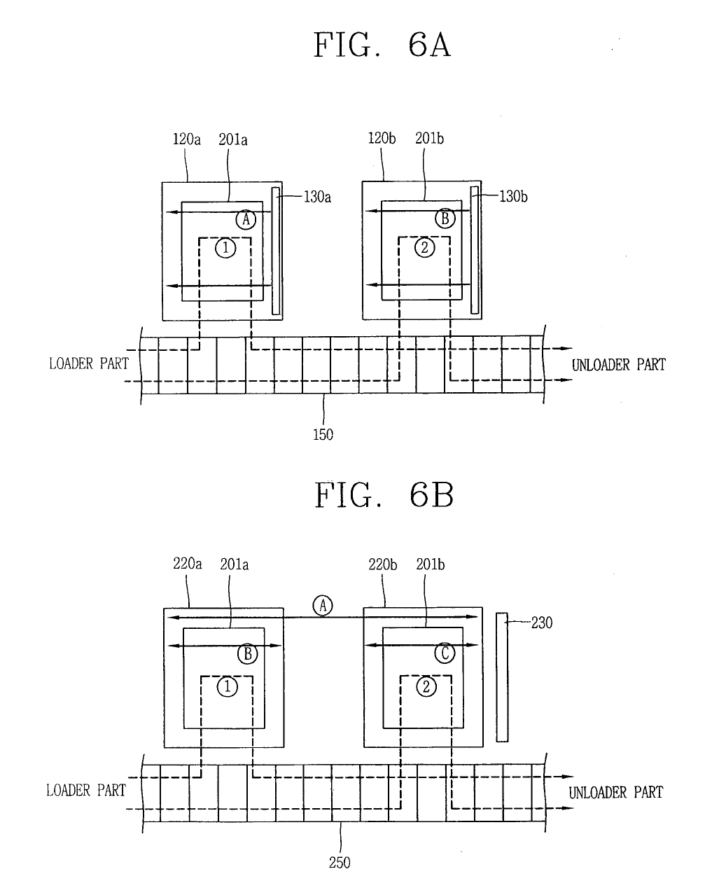

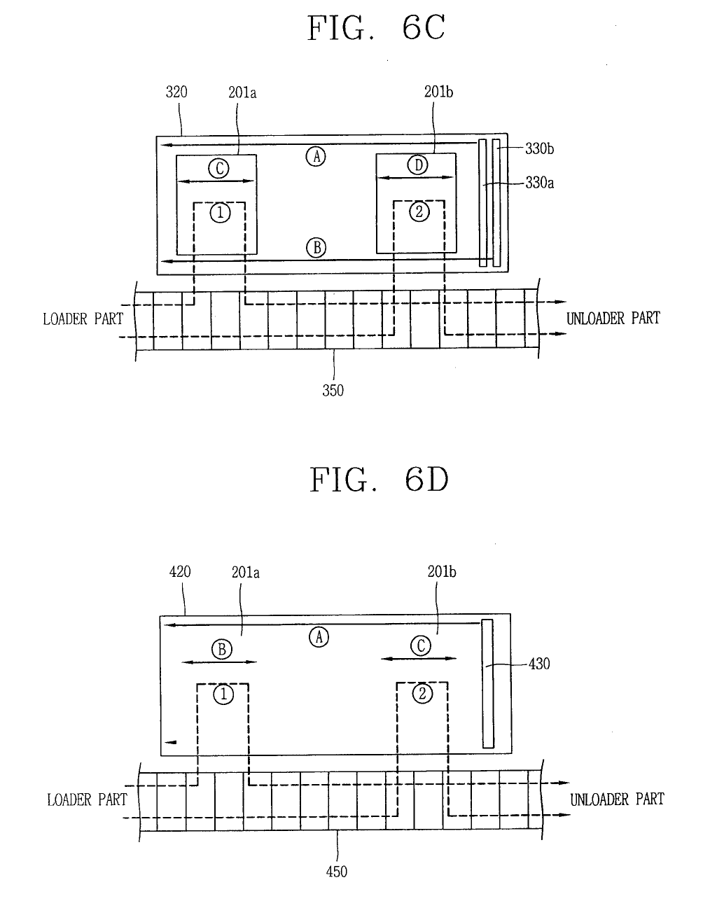

First, referring to FIG. 6A, a plurality of stages 120a and 120b are provided at an inspection part (two stages are shown in the drawing but this disclosure may not be limited to the structure but be applicable to a structure of installing three or more stages). Cameras 130a and 130b may be installed at the stages 120a and 120b, respectively.

LC panels 201a and 201b may be transported onto the stages 120a and 120b in a state of being loaded on palettes (not shown). Here, the stages 120a and 120b may be connected to a loader part and an unloader part via the conveyer 150 such that the LC panels 201a and 201b can be transported from the loader part to the first and second stages 120a and 120b and transported from the first and second stages 120a and 120b to the unloader part. Here, the LC panels 201a and 201b are transported to the first and second stages 120a and 120b in the state of being loaded on the palettes. However, the description of the palettes is omitted for the sake of brief description and rather the LC panels 201a and 201b are directly disclosed.

Here, the transport of the first and second LC panels 201a and 201b to the first and second stages 120a and 120b may be performed in a sequential manner. That is, after the first LC panel 201a is transported to the first stage 120a by the conveyer 150 (i.e., transported along the path indicated with \textcircled{1} in the drawing), the second LC panel 201b is transported to the second stage 120b by the conveyer 150 (i.e., transported along the path indicated with \textcircled{2} in the drawing).

After the first LC panel 201a is completely loaded on the first stage 120a, the first camera 130a installed at the first stage 120a receives a test signal applied via a probe unit formed at the palette to photograph (scan) the first LC panel 201a, on which a test image is displayed, thereby performing inspection of the first LC panel 201a. Here, the first camera 130a may be a line scan camera or an area camera. The line scan camera may consecutively be moved by a linear motor or the like to photograph the first LC panel 201, whereas the area camera may inconsecutively be moved by a step motor or the like to photograph a specific area.

The first camera 130a may be disposed at one side of the first stage 120a. Upon the first LC panel 201a being loaded, the first camera 130a may move from the one side to another side to photograph the first LC panel 201a (i.e., photographing with moving along the path indicated with \textcircled{A} in the drawing).

Here, the first camera 130a may photograph the first LC panel 201a even at the moment when the second LC panel 201b is transported to the second stage 120b by the conveyer 150. The completely photographed first LC panel 201a may then be conveyed to the unloader part by the conveyer 150 along path \textcircled{1}.

After the second LC panel 201b is loaded on the second stage 120b, the second camera 130b installed at the second stage 120b may receive a test signal applied via a probe unit formed at the palette to scan the second LC panel 201b, on which a test image is displayed, thereby performing inspection of the second LC panel 201b.

The second camera 130b may be disposed at one side of the second stage 120b. Upon the second LC panel 201b being loaded, the second camera 130b may move from the one side to another side to photograph the second LC panel 201b (i.e., photographing with moving along the path indicated with \textcircled{B} in the drawing).

Here, the second camera 130b may photograph the second LC panel 201b even at the moment when the completely inspected first LC panel 201a is conveyed to the unloader part by the conveyer 150 along path \textcircled{1}. The completely photographed second LC panel 201b may then be conveyed to the unloader part by the conveyer 150 along path \textcircled{2}.

Thus, in the inspection apparatus with this structure, after the camera 130a and 130b are installed at the plurality of stages 120a and 120b, respectively, the cameras 130a and 130b can be separately run to inspect the LC panels 201a and 201b loaded, thereby allowing a rapid inspection of the LC panels 201 and 201b. Here, although not shown, to avoid interruption between the plurality of LC panels 201a and 201b when the plurality of LC panels 201a and 201b, which have undergone the previous bonding process and cutting process, are loaded on or unloaded from the plurality of stages 120a and 120b, a buffer unit may be provided to temporarily keep the LC panels 201a and 201b for a sequential transport of the LC panels 201a and 201 loaded on or unloaded from the plurality of stages 120a and 120b.

FIG. 6B illustrates a structure of an inspection apparatus that a plurality of stages 220a and 220b are provided at an inspection part and one camera 230 is installed, so as to inspect LC panels 201a and 201b loaded on the plurality of stages 120a and 120b by using the one camera 230.

As illustrated in FIG. 6B, the first and second LC panels 201a and 201b may be transported to the first stage 220a and the second stage 220b, respectively, in a state of being loaded on palettes (not shown). Here, the first stage 220a and the second stage 220b may be connected to a loader part and an unloader part via a conveyer 250 such that the first and second LC panels 201a and 201b can be transported from the loader part to the first and second stages 220a and 220b and transported from the first and second stages 220a and 220b to the unloader part.

Here, the transport of the first and second LC panels 201a and 201b to the first and second stages 220a and 220b may be performed in a sequential manner. That is, after the first LC panel 201a is transported to the first stage 220a by the conveyer 250 (along path \textcircled{1}), the second LC panel 201b is transported to the second stage 220b by the conveyer 250 (i.e., along path \textcircled{2}).

The camera 230 may be installed at a specific stage 220a, 220b or outside the stages 220a and 220b so as to be movable to inside and outside of the stages 220a and 220b.

After the first and second LC panels 201a and 201b are loaded on the first and second stages 220a and 220b, respectively, the camera 230 may scan the first and second LC panels 201a and 201b so as to perform the inspection of the LC panels 201a and 201b.

Here, the camera 230 may cover both the first and second stages 220a and 220b. That is, the camera 230 may be moved toward the stages 220a and 220b having the LC panels 201a and 201 loaded so as to scan the loaded LC panels 201a and 201 within the stages 220a and 220b, thereby performing the inspection.

When the first LC panel 201a is loaded on the first stage 220a, the camera 230 is moved to the first stage 220a along path \textcircled{A}, and then moved or reciprocated in the first stage 220a along path \textcircled{B} to photograph the first LC panel 201a for inspection.

When the second LC panel 201b is loaded on the second stage 220b, the camera 230 is moved to the second stage 220b along path \textcircled{A}, and then moved or reciprocated in the second stage 220b along path \textcircled{C} to photograph the second LC panel 201b for inspection.

The photographing of the camera 230 may be continued while transporting the LC panels 201a and 201b. That is, at the moment when the second LC panel 201b is transported to the second stage 220b by the conveyer 250, the camera 230 is moved to the first stage 220a along path \textcircled{A}, and thereafter moved or reciprocated along path \textcircled{B} to photograph the first LC panel 201a. Also, at the moment when the first LC panel 201a is transported from the first stage 220a a to the unloader part by the conveyer 250, the camera 230 is moved to the second stage 220b along path \textcircled{A}, and then moved or reciprocated in the second stage 220b along path \textcircled{C} to photograph the second LC panel 201b. Also, the movement of the camera 230 will be the same in the reverse case.

As such, in the inspection apparatus with this structure, the one camera 230 may be installed at the plurality of stages 220a and 220b to be moved above the plurality of stages 220a and 220b so as to scan the LC panels 201a and 201b loaded on the respective stages 220a and 220b, thereby allowing a rapid inspection of the LC panels 201a and 201b. In addition, since the LC panels 201a and 201b are sequentially loaded on the stages 220a and 220b to be inspected and an inspection of another LC panel on another stage is in progress while the LC panels 201a and 201b are transported, the rapid inspection can be implemented.

Also, the buffer unit may also be provided in this inspection apparatus to avoid interruption between the plurality of LC panels 201a and 201b passed through the previous bonding process and cutting process when they are loaded on or unloaded from the plurality of stages 220a and 220b.

FIG. 6C illustrates an inspection apparatus having a structure that a plurality of cameras 330a and 330b are installed at one stage 320 of an inspection part and a plurality of LC panels 201a and 201b are loaded on the one stage 320 to be inspected.

As illustrated in FIG. 6C, in this structure, the first and second LC panels 201a and 201b may be transported to the one stage 320 in a state of being placed on palettes (not shown). Here, the stage 320 may be connected to a loader part and an unloader part via a conveyer 350, such that the first and second LC panels 201a and 201b can be transported from the loader part to the stage 320 and transported from the stage 320 to the unloader part.

Here, the transport of the first and second LC panels 201a and 201b to the stage 320 may be performed in a sequential manner. That is, after the first LC panel 201a is transported to one region of the stage 320 by the conveyer 350 (along path \textcircled{1}), the second LC panel 201b is transported to another region of the stage 320 by the conveyer 350 (i.e., along path \textcircled{2}).

First and second cameras 330a and 330b may be moved within the stage 320 to scan the LC panels 201a and 201b loaded on the different regions.

The first and second cameras 330a and 330b may be disposed at one side of the stage 320. Upon the first LC panel 201a being loaded, the first camera 330a is moved from one side to another side along path \textcircled{A} to thereafter scan the first LC panel 201a along path \textcircled{C}. Here, the first camera 330a may scan (photograph) the first LC panel 201a even at the moment when the second LC panel 201b is transferred to the stage 320 by the conveyer 350. The completely photographed first LC panel 201a may then be conveyed to the unloader part by the conveyer 350 along path \textcircled{1}.

After the second LC panel 201b is loaded on the stage 320, the second camera 330b is moved from one side to another side along path \textcircled{B} to thereafter scan the second LC panel 201b along path \textcircled{D}. Here, the second camera 330b may scan (photograph) the second LC panel 201b even at the moment when the first LC panel 201a is transferred to the unloader part by the conveyer 350. The completely photographed second LC panel 201b may then be transferred to the unloader part by the conveyer 350 along the path \textcircled{2}. Also, the second camera 330b may scan the second LC panel 201b even at the moment when the first camera 330a scans the first LC panel 201a.

Meanwhile, the first and second cameras 330a and 330b may not scan the LC panels 201a and 201b loaded on specific regions of the stage 320, respectively. That is, the fist camera 330a may scan either the first LC panel 201a loaded on the stage 320 or the second LC panel 201b loaded on the stage 320. In other words, one of the first and second cameras 330a and 330b may scan, if necessary, both the two LC panels 201a and 201b loaded on the stage 320.

As such, in the inspection apparatus with this structure, the plurality of cameras 330a and 330b are installed at the one stage 320 to scan the LC panels 201a and 201b, respectively, thereby allowing a rapid inspection of the LC panels 201a and 201b. Here, although not shown, to avoid interruption between the plurality of LC panels 201 a and 201b when the plurality of LC panels 201a and 201b, which have undergone the previous bonding process and cutting process, are loaded on or unloaded from the stage 320, a buffer unit may be provided to temporarily keep the LC panels 201a and 201b.

FIG. 6D illustrates an inspection apparatus having a structure that one camera 430 is installed at one stage 420 and a plurality of LC panels 201a and 201b are loaded on the one stage 420 for inspection.

As illustrated in FIG. 6D, the first and second LC panels 201a and 201b may be transported to the one stage 420 in a state of being loaded on palettes (not shown). Here, the stage 420 may be connected to a loader part and an unloader part via a conveyer 450, such that the first and second LC panels 201a and 201b can be transported from the loader part to the stage 420 and transported from the stage 420 to the unloader part.

Here, the transport of the first and second LC panels 201a and 201b to the stage 420 may be performed in a sequential manner. That is, after the first LC panels 201a is transported to one region of the stage 420 by the conveyer 450 (along path \textcircled{1}), the second LC panel 201b is transported to another region of the stage 420 by the conveyer 450 (i.e., along path \textcircled{2}).

The camera 430 may be moved from one side to another side of the stage 420. After the first and second LC panels 201a and 201b are loaded on the stage 420, the camera 430 may scan the first and second LC panels 201a and 201b to perform inspection.

Here, the camera 430 may be moved from one side to another side of the entire stage 420. That is, the camera 430 may be moved within the stage 420, on which the LC panels 201a and 201b are loaded, and scan the LC panels 201a and 201b loaded on the respective regions of the stage 420 to perform inspection.

When the first LC panel 201a is loaded on one region of the stage 420, the camera 430 is moved within the stage 420 along path \textcircled{A} to be present above the first LC panel 201a, and in this state, moved or reciprocated along path \textcircled{B} to scan the first LC panel 201a.

After a complete inspection, the first LC panel 201a may be transported from the state 420 to the unloader part by the conveyer 450. Simultaneously, the camera 430 is moved to another region of the stage 420 along path \textcircled{A} and thereafter moved or reciprocated along path \textcircled{C} to scan the second LC panel 201b loaded on the corresponding region.

Here, the scanning of the first LC panel 201a by the camera 430 may be executed even at the moment when the second LC panel 201b is transported to the stage 420, and also the scanning of the second LC panel 201b by the camera 430 may be executed even at the moment when the first LC panel 201a is transferred to the unloader part.

As such, in the inspection apparatus with this structure, the one camera 430 is installed at the one stage 420. However, after the plurality of LC panels 201a and 201b are loaded on the stage 420, the camera 430 may be moved above the stage 420 to scan the plurality of LC panels 201a and 201b, thereby allowing a rapid inspection. In addition, since the LC panels 201a and 201b are sequentially loaded on the stage 420 to be inspected and another LC panel are inspected during transport of the LC panels 201a and 201b (or the LC panels are transported during scanning of the LC panels 201a and 201b), the rapid inspection can be implemented.

Also, in the inspection apparatus with this structure, a buffer unit may be provided to avoid interruption between the plurality of LC panels 201a and 201b when the plurality of LC panels 201a and 201b, which have undergone the previous bonding process and cutting process, are loaded on or unloaded from the stage 420.

As aforesaid, after a plurality of LC panels 201a and 201b are loaded on one stage or a plurality of stages, the plurality of LC panels 201a and 201b can be simultaneously or sequentially photographed (scanned) by one camera or a plurality of cameras, which allows a rapid inspection. Furthermore, when one LC panel is loaded or unloaded, another LC panel can be inspected, resulting in allowing an efficient inspection.

Meanwhile, the present disclosure may not be limited to the inspection as to existence or non-existence of a defect on the LC panels 201a and 201b by photographing test images rendered on the LC panels 201a and 201b using a camera disposed above the LC panel 201a and 201b to scan them, but can also execute a viewing angle inspection of the LC panels 201a and 201b.

That is, the inspection part may further include a viewing angle inspection camera located in a diagonal direction with an inclination angle of about 45° for performing a viewing angle inspection. An angle of the viewing angle inspection camera may be adjustable such that the viewing angle inspection camera can be inclined from a left/right direction of the LC panel 201a, 201b to the diagonal direction thereof for viewing angle inspection of the LC panel 201a, 201b. Here, the viewing angle inspection camera may be a line scan camera.

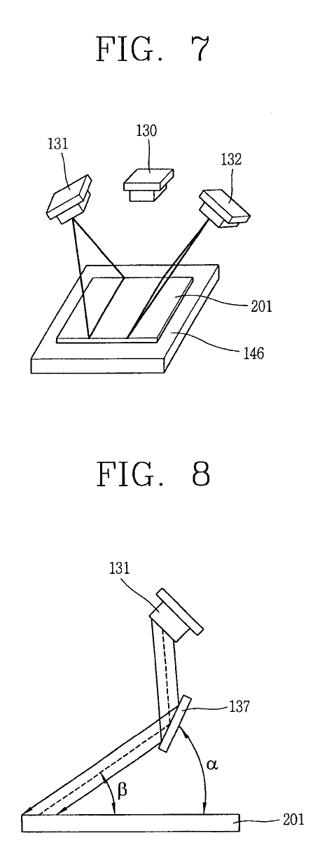

FIG. 7 illustrates a camera 130 for detecting a defect of an LC panel 201 by taking test images and viewing angle inspection cameras 131 and 132 for inspecting a viewing angle.

As illustrated in FIG. 7, the defect inspection camera 130 may be disposed above the front of an LC panel 201, and the first viewing angle inspection camera 131 and the second viewing angle inspection camera 132 may be disposed above both side surfaces thereof. The first viewing angle inspection camera 131 may scan the LC panel 201 in an inclined state from the left direction to the diagonal direction of the LC panel 201, and the second viewing angle inspection camera 132 may scan the LC panel 201 in an inclined state from the right direction to the diagonal direction of the LC panel 201, thereby executing the left/right viewing angle inspection of the LC panel 201.

Thus, the inspection apparatus for the display device in the detailed description can substitute the existing method of inspecting a viewing angle by inspector's naked eyes, by employing the viewing angle inspection cameras 131 and 132, thereby realizing an accurate and fast inspection.

Here, the viewing angle inspection cameras 131 and 132 may inspect viewing angles by being inclined in a certain direction. In this case, a focal point may differ and accordingly a screen may partially look stained, which disables defect detection or causes a detection error.

Referring to FIG. 8, a plane mirror 137 may be provided between the LC panel 201 and the viewing angle inspection camera 131 to avoid the detection error. Accordingly, an image, which is incident on the LC panel 201, may be reflected in directions \textcircled{A} and \textcircled{B} perpendicular to a detection surface, thereby making a focal distance within the detection surface the same. An image with the same focal distance may be obtained as a clear image within the viewing angle inspection camera 131.

An angle of the plane mirror 137 may be calculated according to the following Equation.

α=90−β/2,

wherein α denotes an angle of the plane mirror 137 and β denotes an off-axis angle between the LC panel 201 and the detection surface.

As described, after a plurality of LC panels are loaded on one stage or a plurality of stages, the loaded LC panels can be scanned (photographed, taken, captured) simultaneously or sequentially by one camera or a plurality of cameras, thereby allowing a rapid inspection. Furthermore, upon loading or unloading one LC panel, another LC panel can be inspected, so as to realize an efficient inspection.

Also, viewing angle inspection cameras may also be equipped in addition to the camera(s), so as to allow a fast and accurate viewing angle inspection as well as a defect inspection.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An inspection apparatus for a display device comprising:
a plurality of stages on which at least one display panel is loaded; and
a first camera at one of the plurality of stages to photograph a display panel loaded on the corresponding stage with moving from one side to another side of the display panel to inspect a defect of the display panel.

2. The apparatus of claim 1, wherein the first camera is a line scan camera, an area camera or time delay and integration (TDI) camera.

3. The apparatus of claim 1, further comprising:
a loader unit to load the display panel thereon and transport the loaded display panel for the succeeding process; and
an unloader unit to unload the display panel inspected on a stage.

4. The apparatus of claim 1, further comprising:
a first conveying unit to transport the display panel to the loader unit, the stage and the unloader unit;
a second conveying unit to transport the display panel loaded on a stage to a position where the camera is located; and
means for moving the first camera.

5. The apparatus of claim 1, further comprising a palette to support each display panel.

6. The apparatus of claim 1, further comprising a plurality of second cameras for viewing angle inspection, disposed at the plurality of stages, respectively, and inclined by a preset angle in a diagonal direction of the display panel to execute a left and right viewing angle inspection of the display panel loaded on the corresponding stage.

7. The apparatus of claim 6, wherein a plane mirror inclined by a preset angle is disposed between the second camera and the display panel.

8. The apparatus of claim 1, wherein the first camera photographs a display panel on a corresponding stage while another display panel is loaded on or unloaded from another stage.

9. The apparatus of claim 1, wherein one first camera is disposed at each stage.

10. The apparatus of claim 9, wherein the first camera is moved and reached at one side of the display panel loaded on a stage and then moving from the reached side to another side of the display panel to photograph the display panel.

11. The apparatus of claim 1, wherein a plurality of first cameras are disposed at one stage and a plurality of display panels are loaded on the one stage.

12. The apparatus of claim 11, wherein one of the first cameras is moved to one region of a plurality of regions where the plurality of display panels are located on the corresponding stage so as to photograph a display panel present on the corresponding region, and another first camera is moved to another region to photograph a display panel present on the corresponding region.

13. The apparatus of claim 12, wherein while a display panel is loaded on one region of the plurality of regions, the first camera photographs a display panel loaded on another region.

14. The method of claim 1, wherein the display panel includes a liquid crystal display panel, an organic light emitting diode device, a plasma display panel, and a solar cell.

15. An inspection apparatus for a display device comprising:
a plurality of stages on which a plurality of display panels are loaded, respectively; and
a plurality of first cameras to move among the plurality of stages, the plurality of first cameras photographing the plurality of display panels loaded on the respective stages, with moving from one side to another of the display panels, so as to inspect defects of the display panels.

16. The apparatus of claim 15, wherein while one display panel is loaded on or unloaded from one stage, the first camera photographs a display panel loaded on another stage.

17. The apparatus of claim 15, further comprising a plurality of second cameras for viewing angle inspection, inclined by a preset angle in a diagonal direction of a display panel loaded on each stage to execute a right and left viewing angle inspection of the display panel.

18. An inspection method for a display device comprising:
loading display panels on a plurality of stages, respectively; and
disposing at least one camera at each of a plurality of stages to photograph the display panel loaded on the corresponding stage, with moving the at least one camera from one side to another of the display panel, to inspect a defect of the display panel.

19. The method of claim 18, wherein the photographing of the display panels comprises photographing the display panels loaded on the corresponding stages by a plurality of cameras.

20. The method of claim 18, wherein the photographing of the display panels comprises:
loading or unloading a display panel on or from one stage; and
photographing a display panel loaded on another stage by the camera.

21. The method of claim 18, wherein the photographing of the display panels comprises:
moving one camera to one region of one stage having a plurality of regions to photograph the display panel on the corresponding region and moving another camera to another region of the one stage to photograph the display panel on the corresponding region.

22. The method of claim 18, wherein the photographing of the display panel comprises:
loading or unloading the display panel on or from one region of one stage having a plurality of regions; and
moving the camera to another region of the one stage to photograph a display panel on the corresponding region.

23. An inspection method for a display device comprising:
loading display panels on each stage of a plurality of stages;
disposing a camera above a display panel loaded on one stage to photograph the display panel with moving the camera from one side to another of the display panel;
moving the camera to another stage; and
disposing the camera above a display panel loaded on the another stage to photograph the display panel with moving the camera from one side to another of the display panel.
